(19) United States
(12) Patent Application Publication
(10) Pub. No.: US 2024/0129630 A1
(43) Pub. Date: Apr. 18, 2024

(54) IMAGE-CAPTURING SYSTEM, IMAGE-CAPTURING DEVICE, AND IMAGE-CAPTURING METHOD

(71) Applicant: Hiroyoshi SEKIGUCHI, Kanagawa (JP)

(72) Inventor: Hiroyoshi SEKIGUCHI, Kanagawa (JP)

(73) Assignee: Ricoh Company, Ltd., Tokyo (JP)

(21) Appl. No.: 18/480,967

(22) Filed: Oct. 4, 2023

(30) Foreign Application Priority Data
Oct. 13, 2022 (JP) 2022-164992
Aug. 21, 2023 (JP) 2023-134288

(51) Int. Cl. H04N 23/68; G01S 17/46

(52) U.S. Cl. CPC H04N 23/683; G01S 17/46; H04N 23/6811

(57) ABSTRACT

An image-capturing system includes circuitry to receive multiple phase images for each of multiple phases. The multiple phase images include multiple first phase images captured under a first condition and one or more second phase images captured under a second condition different from the first condition, and the multiple first phase images are greater in number than the one or more second phase images. The circuitry calculates, for each of the multiple phases, a motion amount, at least, among the multiple first phase images of a same phase; performs correction on the multiple first phase images of the same phase based on the motion amount; and performs addition processing on the multiple first phase images of the same phase, so as to generate a summed phase image for each of the multiple phases.

### CROSS-REFERENCE TO RELATED APPLICATIONS

This patent application is based on and claims priority pursuant to 35 U.S.C. § 119(a) to Japanese Patent Application Nos. 2022-164992, filed on Oct. 13, 2022, and 2023-134288, filed on Aug. 21, 2023, in the Japan Patent Office, the entire disclosure of which is hereby incorporated by reference herein.

### BACKGROUND

### Technical Field

Embodiments of the present disclosure relate to an image-capturing system, an image-capturing device, and an image-capturing method.

### Related Art

Indirect time-of-flight (ToF) sensing is known as a technology for measuring the distance to an object. In indirect ToF sensing, the object is irradiated with reference light having a modulated intensity, and the light reflected from the object is received, so as to obtain four kinds of phase images that are shifted in phase from each other, for distance measuring. Based on the conversion of the phase images, one distance image indicating the distance to the object is generated. For example, data of a construction site or an indoor space is acquired, and a point cloud can be reproduced as three-dimensional space restoration data by performing post-stage processing, which may be provided by a cloud service. If a tripod (or some mount) is required in acquiring data, for example, the equipment for acquiring data is bulky, and it takes time to capture an image. In a narrow space such as an attic space, it is difficult to use the tripod. To avoid such situations, a hand-held device for image capturing is used.

### SUMMARY

According to an embodiment, an image-capturing system includes circuitry to receive multiple phase images for each of multiple phases. The multiple phase images include multiple first phase images captured under a first condition and one or more second phase images captured under a second condition different from the first condition, and the multiple first phase images are greater in number than the one or more second phase images. The circuitry calculates, for each of the multiple phases, a motion amount, at least, among the multiple first phase images of a same phase; performs correction on the multiple first phase images of the same phase based on the motion amount; and performs addition processing on the multiple first phase images of the same phase, so as to generate a summed phase image for each of the multiple phases.

According to another embodiment, an image-capturing device includes an image-capturing sensor to receive reflected light of irradiation light emitted from a light source and reflected by an object, to perform image capturing, and circuitry. The controls the image-capturing sensor to receive the reflected light so as to capture multiple phase images for each of multiple phases. The multiple phase images include multiple first phase images captured under a first condition and one or more second phase images captured under a second condition different from the first condition. The multiple first phase images are greater in number than the one or more second phase images. The circuitry calculates, for each of the multiple phases, a motion amount, at least, among the multiple first phase images of a same phase; performs correction on the multiple first phase images of the same phase based on the motion amount; and performs addition processing on the multiple first phase images of the same phase, so as to generate a summed phase image for each of the multiple phases.

According to another embodiment, an image-capturing method includes receiving, with an image-capturing sensor, reflected light of irradiation light emitted from a light source and reflected by an object, to perform image capturing; and controlling the image-capturing sensor to receive the reflected light so as to capture multiple phase images for each of multiple phases. The multiple phase images include multiple first phase images captured under a first condition and one or more second phase images captured under a second condition different from the first condition. The multiple first phase images are greater in number than the one or more second phase images. The method further includes calculating, for each of the multiple phases, a motion amount, at least, among the multiple first phase images of a same phase; performing correction on the multiple first phase images of the same phase based on the motion amount; and performing addition processing on the multiple first phase images of the same phase, so as to generate a summed phase image for each of the multiple phases.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1A is a schematic block diagram illustrating a configuration of an image-capturing system according to one embodiment of the present disclosure;

FIG. 1B is a schematic block diagram illustrating another configuration of the image-capturing system according to one embodiment of the present disclosure;

FIG. 2 is a diagram illustrating a pixel configuration of a light-receiving sensor according to one embodiment of the present disclosure;

FIG. 3 is a graph illustrating a delay between irradiation light and reflected light in the image-capturing system according to one embodiment of the present disclosure;

FIG. 4 is a timing chart illustrating a relation among a modulation signal, irradiation light, reflected light, and transfer signals in the image-capturing system according to one embodiment of the present disclosure;

FIG. 5 is a chart illustrating a principle of distance measuring by a sinusoidal modulation method according to one embodiment of the present disclosure;

FIG. 6 is a chart illustrating a principle of distance measuring by a pulse modulation method according to one embodiment of the present disclosure;

FIG. 7 is a diagram illustrating image-capturing timing of multiple phase images in the image-capturing system according to one embodiment of the present disclosure;

FIG. 8 is a diagram illustrating another image-capturing timing of multiple phase images in the image-capturing system according to one embodiment of the present disclosure;

FIG. 9 is a diagram illustrating yet another image-capturing timing of multiple phase images in the image-capturing system according to one embodiment of the present disclosure;

FIG. 10 is a diagram illustrating selection of a reference phase image from among the phase images captured by the image-capturing system according to one embodiment of the present disclosure;

FIG. 11 is a diagram illustrating another selection of the reference phase image from among the phase images captured by the image-capturing system according to one embodiment of the present disclosure;

FIG. 12 is a diagram illustrating yet another selection of the reference phase image from among the phase images captured by the image-capturing system according to one embodiment of the present disclosure;

FIG. 13 is a diagram illustrating yet another selection of the reference phase image from among the phase images captured by the image-capturing system according to one embodiment of the present disclosure;

FIG. 14A is a diagram illustrating phase images before shaking correction by the image-capturing system according to one embodiment of the present disclosure;

FIG. 14B is a diagram illustrating phase images after shaking correction by the image-capturing system according to one embodiment of the present disclosure;

FIG. 15 is a diagram illustrating a screen image displaying a distance image obtained without the shaking correction and a distance image obtained with the shaking correction by the image-capturing system according to one embodiment of the present disclosure;

FIG. 16 is a schematic block diagram illustrating a configuration of an image-capturing system according to a modification of the above-described embodiment; and

FIGS. 17A and 17B are flowcharts of a process for generating an image according to one embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In the related art, there is a distance measuring device that emits light from a light source, acquires a phase signal with an image-capturing device, repeatedly stores the acquired phase signal in a storage unit multiple times, and generates a distance image representing the distance to an object calculated from multiple phase signals.

When a hand holding the image-capturing device or the object shakes, a shift occurs in multiple phase images, which degrades the quality of the distance image generated based on the multiple phase images.

According to the embodiments described below, multiple phase images can be processed for reducing a decrease in distance calculation accuracy.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, an image-capturing device, an image-capturing system, and an image-capturing method according to embodiments of the present disclosure are described below. As used herein, the singular forms “a,” “an,” and “the” are intended to include the plural forms as well, unless the context clearly indicates otherwise.

The present invention, however, is not limited to the following embodiments, and constituent elements of the following embodiments include elements easily conceivable by those skilled in the art, substantially the same elements, and elements within so-called equivalent ranges. Furthermore, various omissions, substitutions, changes, and combinations of the constituent elements may be made without departing from the gist of the following embodiments.

Terms used in this disclosure are defined as described below. “Computer software,” which may be referred to simply as “software” in the following description, is defined as a program related to the operation of a computer or any information that is used in processing performed by a computer and equivalent to a program. “Application software,” which may be referred to simply as an “application,” is a generic name for any software used to perform certain processing. By contrast, an “operating system (OS)” is software for controlling a computer to allow, for example, application software to use computer resources. An “OS” controls basic operations of the computer, such as input and output of data, management of hardware resources such as a memory and a hard disk, and processes to be performed.

“Application software” operates by utilizing functions provided by an OS. A “program” is a set of instructions for causing a computer to perform processing to generate a certain result. Information that is not a direct command to a computer is not referred to as a program itself. However, information that defines processing performed by a program is similar in nature to a program and thus is interpreted as equivalent to a program. For example, a data structure, which is a logical structure of data represented by an interrelation between data elements, is interpreted as equivalent to a program.

### Schematic Configuration of Image-Capturing System

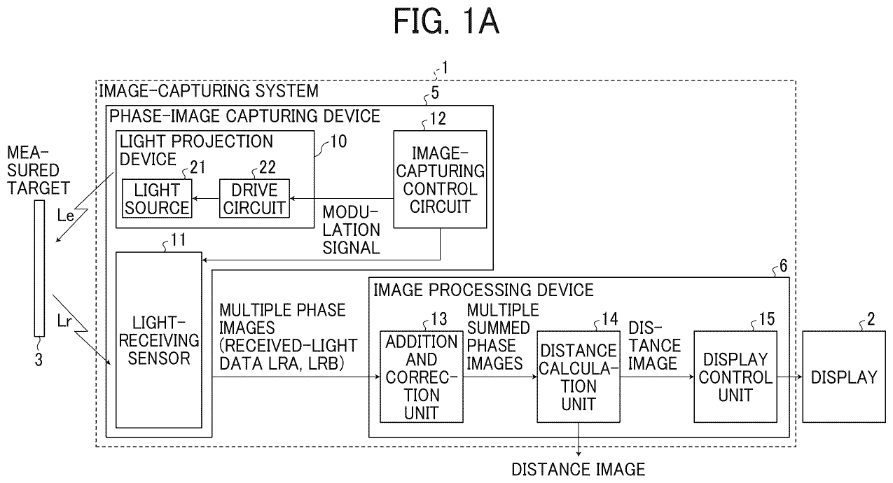

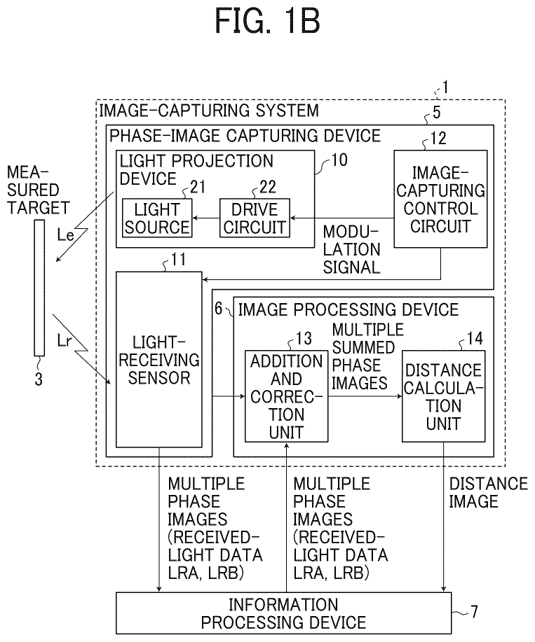

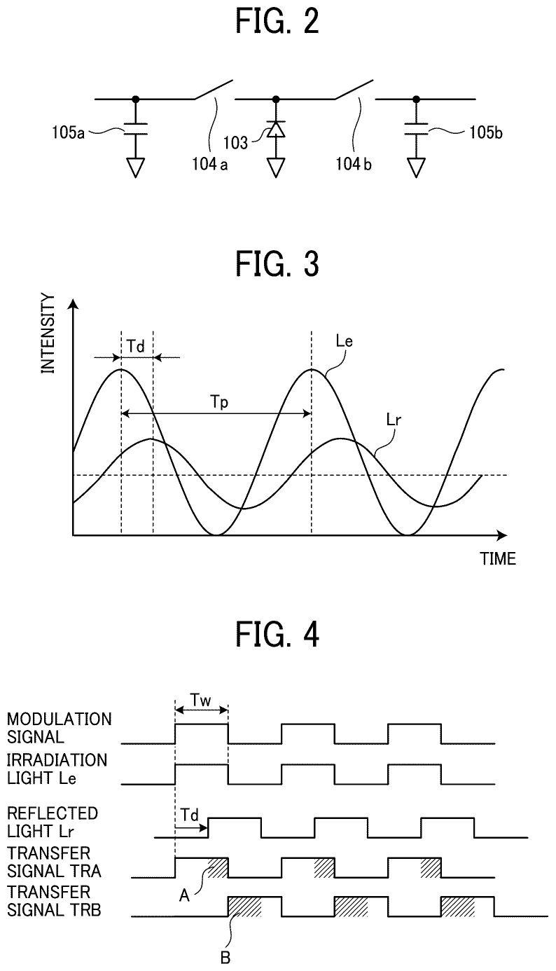

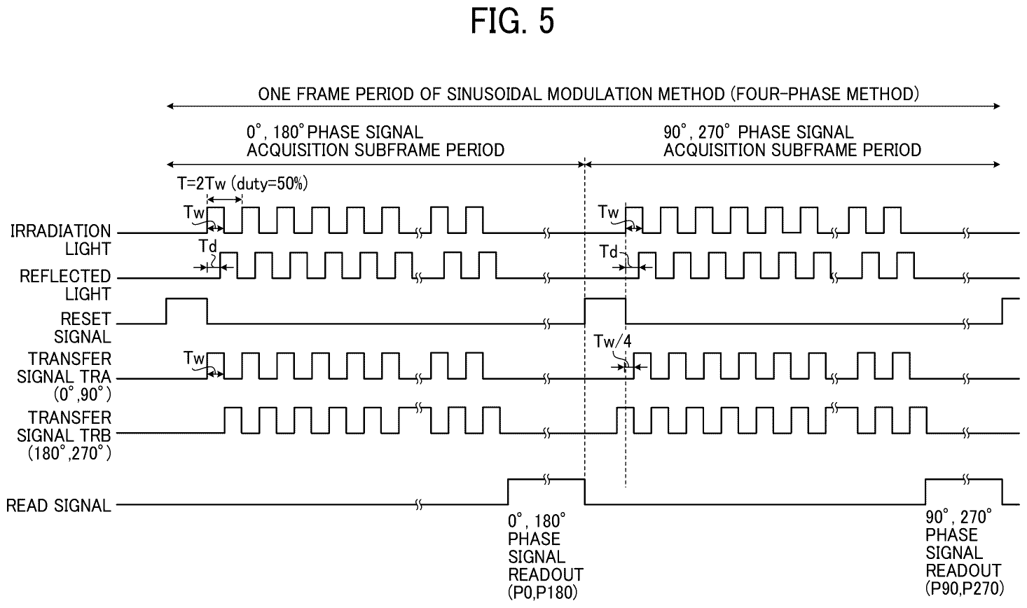

FIGS. 1A and 1B are diagrams each illustrating a schematic configuration of an image-capturing system according to the present embodiment. FIG. 2 is a diagram illustrating a configuration of a pixel in a light-receiving sensor according to the present embodiment. FIG. 3 is a graph illustrating a delay between irradiation light and reflected light in the image-capturing system according to the present embodiment. FIG. 4 is a timing chart illustrating a relation among a modulation signal, irradiation light, reflected light, and transfer signals in the image-capturing system according to the present embodiment. A description is given below of the overview of the configuration and operation of an image-capturing system 1 according to the present embodiment, with reference to FIGS. 1A to 4.

An image-capturing system 1 illustrated in FIGS. 1A and 1B is a system that measures the distance to a measured target 3 that is an object for image capturing, using TOF sensing. As illustrated in FIG. 1A, the image-capturing system 1 includes a phase-image capturing device 5 and an image processing device 6. The phase-image capturing device 5 includes a light projection device 10, a light-receiving sensor 11 (an image-capturing sensor), and an image-capturing control circuit 12. The image processing device 6 includes an addition and correction unit 13 (an addition unit), a distance calculation unit 14 (a distance measurement unit), and a display control unit 15. The configuration of the image-capturing system 1 is not limited to the configuration illustrated in FIG. 1A. For example, a part of the processing units of the image processing device 6 may be included in the phase-image capturing device 5, or a part of the processing units of the phase-image capturing device 5 may be included in the image processing device 6. Yet alternatively, the image-capturing system 1 may include three or more devices to which the processing units of the phase-image capturing device 5 and those of the image processing device 6 are allocated. Yet alternatively, the image-capturing system 1 may be a single apparatus or device (an image-capturing device) including the processing units mentioned above. The image processing device 6 may be an information processing device such as a personal computer (PC) or a system that resides in a cloud environment. The image processing device 6 includes an integrated circuit (IC) dedicated to image processing, such as a field-programmable gate array (FPGA) or an application-specific integrated circuit (ASIC), which has a hardware element for image processing.

The light projection device 10 emits pulsed light (irradiation light Le) toward the measured target 3.

The light projection device 10 includes a light source 21 and a drive circuit 22.

The light source 21 emits pulsed light toward the measured target 3.

The drive circuit 22 drives the light source 21. When receiving a modulation signal from the image-capturing control circuit 12, the drive circuit 22 causes a current corresponding to the modulation signal to flow to the light source 21. As a result, the light source 21 emits the pulsed light that is modulated, toward the measured target 3.

The light-receiving sensor 11 receives reflected light Lr that is light reflected from the measured target 3 being irradiated with the irradiation light Le emitted from the light projection device 10. FIG. 3 illustrates an example of changes in intensity with time of the reflected light Lr when the irradiation light Le is depicted as a sine wave. As illustrated in FIG. 3, when Tp represents a cycle of the irradiation light Le, the light-receiving sensor 11 receives the reflected light Lr of the irradiation light Le reflected from the measured target 3 as light having the cycle Tp delayed by a delay time Td from the cycle Tp of the irradiation light Le.

The light-receiving sensor 11 includes multiple pixels that receive the reflected light Lr. The pixels may be, for example, a two-dimensional array of area sensors. Each pixel includes, for example, a photodiode (PD) 103, modulation switches 104a and 104b, and capacitors 105a and 105b, as illustrated in FIG. 2.

The PD 103 is a diode component that causes a current to flow in a certain direction when detecting (receiving) light.

The modulation switches 104a and 104b are switching elements that include, for example, a metal-oxide-semiconductor (MOS) transistor, a MOS device (e.g., a transfer gate), and a charge-coupled device (CCD). The modulation switches 104a and 104b perform an on/off operation according to a transfer signal from the image-capturing control circuit 12.

The capacitors 105a and 105b are power storage elements. Examples of the power storage elements include a MOS, a CCD, a metal insulator metal (MIM), wiring, and a parasitic capacitance of a p-n junction. The capacitors 105a and 105b accumulate electric charges (may be referred to simply as “charges”) independently of each other. Each of the capacitors 105a and 105b accumulates charges generated by photoelectric conversion according to the light received by the PD 103.

Each pixel of the light-receiving sensor 11 has a pixel structure to allocate the charges to two portions (the capacitors 105a and 105b). With this pixel structure, for example, a signal in one light receiving period can be allocated to a component of 0-degree phase and a component of 180-degree phase. In principle, it is also possible that each pixel has a pixel structure to allocate charges to three or more portions so that a signal in one light receiving period is allocated to three or more phase components. Each pixel receives the reflected light Lr reflected from the measured target 3. Each pixel accumulates charges according to a transfer signal (transfer signals TRA and TRB illustrated in FIG. 4 to be described later) from the image-capturing control circuit 12.

More specifically, in a period in which the transfer signal TRA illustrated in FIG. 4 described later is at an active level, the light-receiving sensor 11 causes the modulation switch 104a of each pixel to be conductive, to accumulate electric charges in the capacitor 105a. The active level is, for example, a high (H) level. Similarly, in a period in which the transfer signal TRB illustrated in FIG. 4 described later is at an active level (for example, H level), the light-receiving sensor 11 causes the modulation switch 104b of each pixel to be conductive, to accumulate electric charges in the capacitor 105b.

When receiving an instruction signal for outputting received-light data from the image-capturing control circuit 12, the light-receiving sensor 11 performs analog-to-digital (A/D) conversion on signals that are voltages converted from charge amounts A and B (see FIG. 4) accumulated in the capacitors 105a and 105b of each pixel. Then, the light-receiving sensor 11 generates received-light data LRA and LRB, and outputs the received-light data LRA and LRB to the addition and correction unit 13.

The image-capturing control circuit 12 repeatedly generates a pulse of the modulation signal and outputs the pulse to the light projection device 10, to control the irradiation operation of the irradiation light Le. In addition, the image-capturing control circuit 12 repeatedly generates a pulse of the transfer signal, to control the light receiving operation of the reflected light Lr performed by the light-receiving sensor 11. To be specific, the image-capturing control circuit 12 repeatedly generates a pulse of the transfer signal TRA for turning on and off the modulation switch 104a of the light-receiving sensor 11, to accumulate the charges in the capacitor 105a. Further, the image-capturing control circuit 12 repeatedly generates a pulse of the transfer signal TRB for turning on and off the modulation switch 104b of the light-receiving sensor 11, to accumulate the charges in the capacitor 105b. After the accumulation of charges in the capacitors 105a and 105b are repeated for a predetermined number of times (a predetermined number of pulses are generated), the image-capturing control circuit 12 stops outputting the modulation signal, the transfer signal TRA, and the transfer signal TRB. Then, the image-capturing control circuit 12 outputs the instruction signal to the light-receiving sensor 11 so as to control the light-receiving sensor 11 to output the received-light data LRA and LRB to the addition and correction unit 13. Alternatively, the image-capturing control circuit 12 may store the received-light data LRA and LRB from the light-receiving sensor 11 in a memory such as a random access memory (RAM) of the phase-image capturing device 5 and output the received-light data LRA and LRB from the memory to the addition and correction unit 13. Yet alternatively, as illustrated in FIG. 1B, the phase-image capturing device 5 may output the received-light data LRA and LRB to an information processing device 7, such as a PC, external to the image-capturing system 1, and the addition and correction unit 13 may receive the received-light data LRA and LRB from the information processing device 7.

The addition and correction unit 13 is a processing unit that receives, as phase signals, the received-light data LRA and LRB output from the phase-image capturing device 5 or the information processing device 7, and performs the correction for shaking (shaking of a user hand holding the capturing device or shaking of the object) on multiple phase images of two-dimensional phases corresponding to the phase signals for each pixel of the light-receiving sensor 11. The addition and correction unit 13 further performs addition processing on the multiple phase images of the same phase, to generate a summed phase image. The addition and correction unit 13 may be implemented by hardware such as an integrated circuit, or may be implemented as a central processing unit (CPU) or an arithmetic and logic unit executes a program.

The distance calculation unit 14 is a processing unit that generates a distance image indicating the distance to the measured target 3 based on the summed phase image generated by the addition and correction unit 13. In other words, the distance calculation unit 14 calculates the distance to the measured target 3 by generating the distance image. The distance calculation unit 14 may be implemented by hardware such as an integrated circuit, or may be implemented as a CPU or an arithmetic and logic unit executes a program. The distance calculation unit 14 may generate a point cloud of a three-dimensional space from the generated distance image. In addition to outputting the generated distance image to the display control unit 15, the distance calculation unit 14 may be configured to output the generated distance image outside the image-capturing system 1 via, for example, a network interface.

The display control unit 15 is, for example, a control circuit that controls a display 2 illustrated in FIG. 1A to display, for example, the distance image generated by the distance calculation unit 14.

The display 2 displays, for example, the distance image generated by the distance calculation unit 14 under the control of the display control unit 15. The display 2 is, for example, a liquid crystal display (LCD) or an organic electro-luminescence (EL).

In the configuration illustrated in FIG. 1A, the image-capturing system 1 implements the image-capturing function by the light-receiving sensor 11 and the image-capturing control circuit 12, the correction and addition functions by the addition and correction unit 13, the function for generating the distance image by the distance calculation unit 14, and the function for displaying images on the display 2 by the display control unit 15. However, the functions implemented by the image-capturing system 1 are not limited thereto. For example, as illustrated in FIG. 1B, the information processing device 7 that is separate from the image-capturing system 1 may implement a part of the functions of the image-capturing system 1. For example, the information processing device 7 may implement, among the above-described functions, the function for generating the distance image. Alternatively, the information processing device 7 may implement the function for generating the distance image and the function for displaying images on the display 2. Yet alternatively, the information processing device 7 may implement only the function for displaying images on the display 2. Further, some of the functions of the image-capturing system 1 may be omitted. For example, when it is not necessary to display, for example, the distance image generated by the distance calculation unit 14 on the display 2, the display control unit 15 may be omitted as illustrated in FIG. 1B.

An example of the operation of the image-capturing system 1 will be described below with reference to FIG. 4. As illustrated in FIG. 4, when the image-capturing control circuit 12 outputs the modulation signal having a pulse duration (pulse width) Tw to the light projection device 10, the light projection device 10 irradiates the measured target 3 with the irradiation light Le that pulses in synchronization with the modulation signal.

FIG. 4 illustrates the irradiation light Le on the assumption that the phase of the optical waveform of the irradiation light Le is not delayed from the phase of the modulation signal.

When the irradiation light Le is reflected from the measured target 3, the reflected light Lr is received by the light-receiving sensor 11. The waveform of the reflected light Lr illustrated in FIG. 4 is substantially the same as the waveform of the irradiation light Le. The waveform of the reflected light Lr and that of the irradiation light Le are substantially equal in cycle and duty cycle. The duty cycle is, for example, approximately 50%. The waveform of the reflected light Lr is delayed in phase from the waveform of the irradiation light Le by the delay time Td. The waveform of the reflected light Lr indicates that the reflected light Lr is incident on the light-receiving sensor 11 with the delay time Td from the time of irradiation of the irradiation light Le. The delay time Td is the time from when the light projection device 10 emits the irradiation light Le to when the irradiation light Le is reflected from the measured target 3 to the light-receiving sensor 11. The delay time Td depends on the distance to the measured target 3. In other words, when the delay time Td is known, a distance D to the measured target 3 is obtained by following Equation 1 where reference character c represents the speed of light.

D=Td×c/2 Equation 1

In a period in which the transfer signal TRA output from the image-capturing control circuit 12 is at the H level, the modulation switch 104a of each pixel of the light-receiving sensor 11 turns on (to be conductive). As a result, charges are accumulated in the capacitor 105a. Further, in a period in which the transfer signal TRB output from the image-capturing control circuit 12 is at the H level, the modulation switch 104b of each pixel of the light-receiving sensor 11 turns on (to be conductive). As a result, charges are accumulated in the capacitor 105b. The transfer signal TRA maintains the H level in a period substantially the same as the period of irradiation of the irradiation light Le, and transitions from the H level to the L level after the pulse duration Tw. The transfer signal TRB transitions from the L level to the H level almost at the same time as the transfer signal TRA transitions to the L level, and transitions from the H level to the L level after the elapse of the pulse duration Tw from the transition.

In the period during which the transfer signal TRA is at the H level, charges are accumulated in the capacitor 105a. Accordingly, an accumulated charge amount A, representing the amount of charges corresponding to the reflection light Lr, is accumulated in the capacitor 105a during the period indicated by hatching in FIG. 4. Similarly, in the period during which the transfer signal TRB is at the H level, charges are accumulated in the capacitor 105b. Accordingly, an accumulated charge amount B, representing the amount of charges corresponding to the reflection light Lr, is accumulated in the capacitor 105b during the period indicated by hatching in FIG. 4. When the delay time Td is in a range of 0≤Td≤Tw, a relation represented by following Equation 2 is established.

Td/Tw=B/(A+B) Equation 2

According to the above-described Equations 1 and 2, the distance D to the measured target 3 is obtained by following Equation 3 from the accumulated charge amount A of the reflection light Lr in the capacitor 105a and the accumulated charge amount B of the reflection light Lr in the capacitor 105b.

D=B/(A+B)×Tw×c/2 Equation 3

### Principle of Distance Measuring Based on TOF Sensing

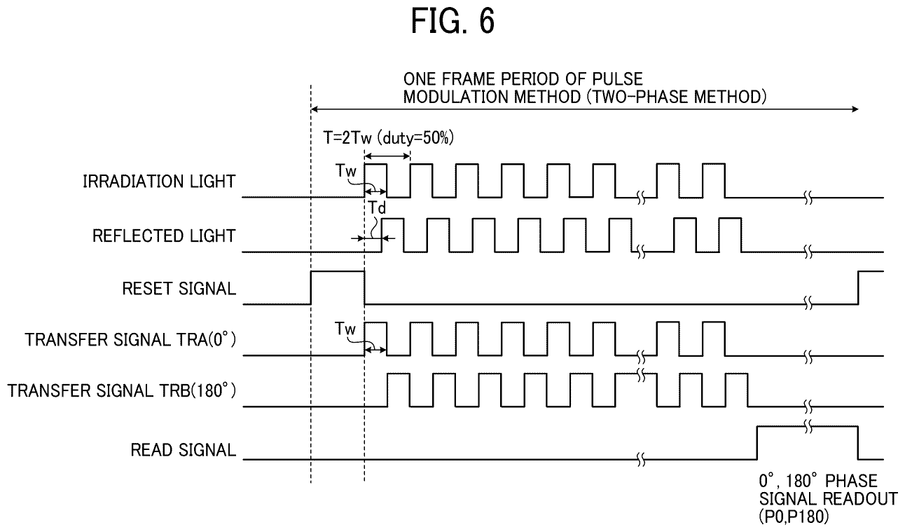

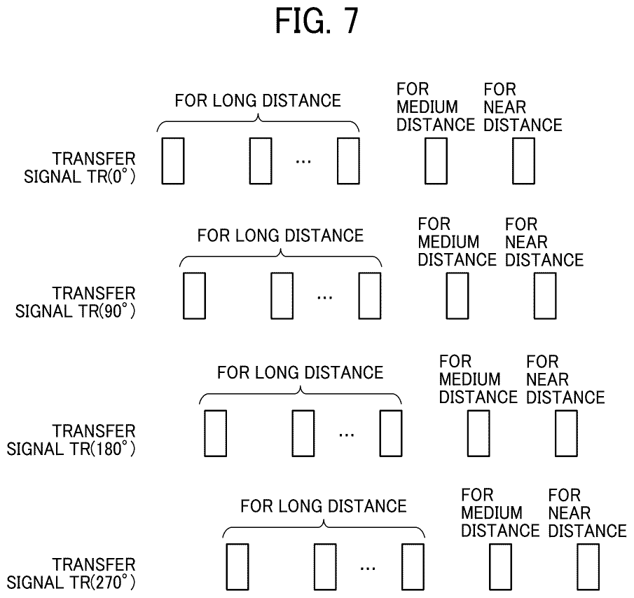

FIG. 5 is a chart illustrating a principle of distance measuring by a sinusoidal modulation method. FIG. 6 is a chart illustrating a principle of distance measuring by a pulse modulation method. With reference to FIGS. 5 and 6, descriptions are given below of the sinusoidal modulation method and the pulse modulation method of the principles of distance measuring based on TOF sensing.

The sinusoidal modulation method is a method for acquiring the delay time Td of the reflected light by calculating a phase difference angle using signals detected by temporally dividing the received light (reflected light) into three or more. As an example, a four-phase sinusoidal modulation method will be described with reference to FIG. 5.

As illustrated in FIG. 5, in the sinusoidal modulation method, one frame period is divided into two subframes, first and second subframe periods. The first subframe period is a frame period for acquiring a 0-degree phase signal and a 180-degree phase signal. The second subframe period is a frame period for acquiring a 90-degree phase signal and 270-degree phase signal.

After each pixel is reset by a reset signal, the irradiation light is cyclically emitted toward the measured target, and the reflected light is cyclically returned. At this time, in the first subframe period, the modulation switches 104a and 104b of the pixels are alternately turned on a predetermined number of times by the transfer signal TRA (0-degree phase) and the transfer signal TRB (180-degree phase), respectively. The transfer signal TRB is shifted in phase from the transfer signal TRA by 180 degrees. Then, phase signals P0 and P180 corresponding to the amounts of charges accumulated temporally corresponding to the 0-degree phase and 180-degree phase are read out with a read signal.

Subsequently, in the second subframe period, the modulation switches 104a and 104b of the pixels are alternately turned on a predetermined number of times by the transfer signal TRA (90-degree phase) and the transfer signal TRB (270-degree phase), respectively. The transfer signal TRB is shifted in phase from the transfer signal TRA by 180 degrees. Then, phase signals P90 and P270 corresponding to the amounts of charges accumulated temporally corresponding to the 90-degree phase and 270-degree phase are read out with the read signal.

When the signals P0, P90, P180, and P270 that are temporally divided into four phases, i.e., 0-degree, 90-degree, 180-degree, and 270-degree phases, are acquired, a phase difference angle Φ is obtained using following Equation 4.

Φ=Arctan{(P90−P270)/(P0−P180)} Equation 4

Using the phase difference angle Φ obtained by Equation 4, the delay time Td of the reflected light from the irradiation light is obtained from following Equation 5.

Td=Φ/2π×T Equation 5

In Equation 5, when Tw represents the pulse duration of the irradiation light, and T represents the cycle, T=2Tw.

From the calculation method of the phase difference angle Φ, an ideal waveform of the irradiation light for enhancing the distance measuring performance in the sinusoidal modulation method is a sine waveform. As in the pixel configuration of the light-receiving sensor 11 illustrated in FIG. 2, when each pixel has two charge allocation destinations (charge capacitors 105a and 105b), the exposure is performed at least twice.

In the above-described example, each pixel has two charge allocation destinations. Alternatively, each pixel may have, for example, four charge allocation destinations, i.e., include four sets of a modulation switch and a capacitor. In this case, the four sets of the modulation switch and the capacitor correspond to the 0-degree, 90-degree, 180-degree, and 270-degree phases, respectively, so that the delay time Td and the distance D to the measured target can be calculated with one exposure. The phases to be read out as phase signals are not limited to the above-described four phases, and phase signals of a different number of phases may be read out.

The pulse modulation method is a method for acquiring the delay time Td of the reflected light by using the signals detected by temporally dividing the received light (reflected light) into two or more signals. As an example, a two-phase pulse modulation method will be described with reference to FIG. 6.

As illustrated in FIG. 6, one frame period for the pulse modulation method is a frame period for acquiring a 0-degree phase signal and 180-degree phase signal.

After each pixel is reset by a reset signal, the irradiation light is cyclically emitted toward the measured target, and the reflected light is cyclically returned. At this time, in one frame period, the modulation switches 104a and 104b of the pixels are alternately turned on a predetermined number of times by the transfer signal TRA (0-degree phase) and the transfer signal TRB (180-degree phase), respectively. The transfer signal TRB is shifted in phase from the transfer signal TRA by 180 degrees. Then, the phase signals P0 and P180 corresponding to the amounts of charges accumulated temporally corresponding to the 0-degree phase and 180-degree phase are read out with a read signal.

When the phase signals P0 and P180 temporally divided into two phases, 0-degree and 180-degree phases, are obtained, the delay time Td of the reflection light from the irradiation light can be obtained by using following Equation 6.

Td={P180/(P0+P180)}×Tw Equation 6

From the calculation method of the delay time Td, an ideal waveform of the irradiation light for enhancing the distance-measuring performance in the pulse modulation method is a rectangular waveform.

### Image-Capturing Timing of Phase Image

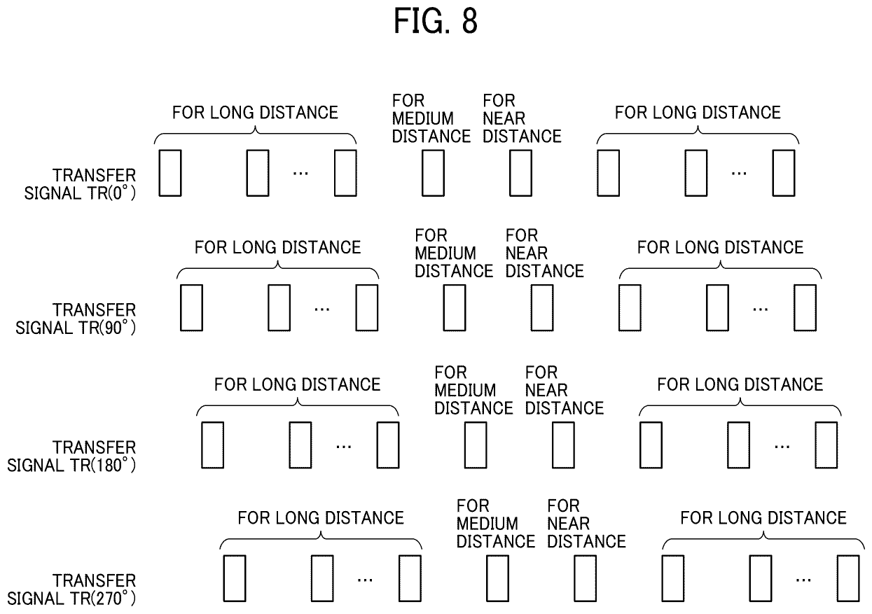

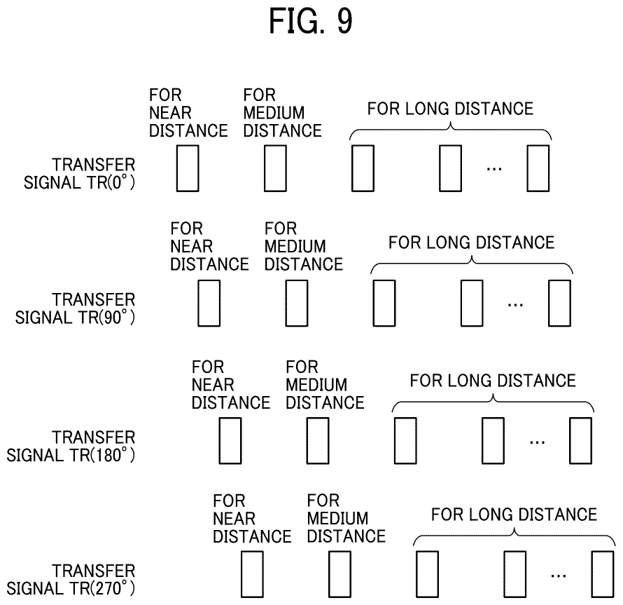

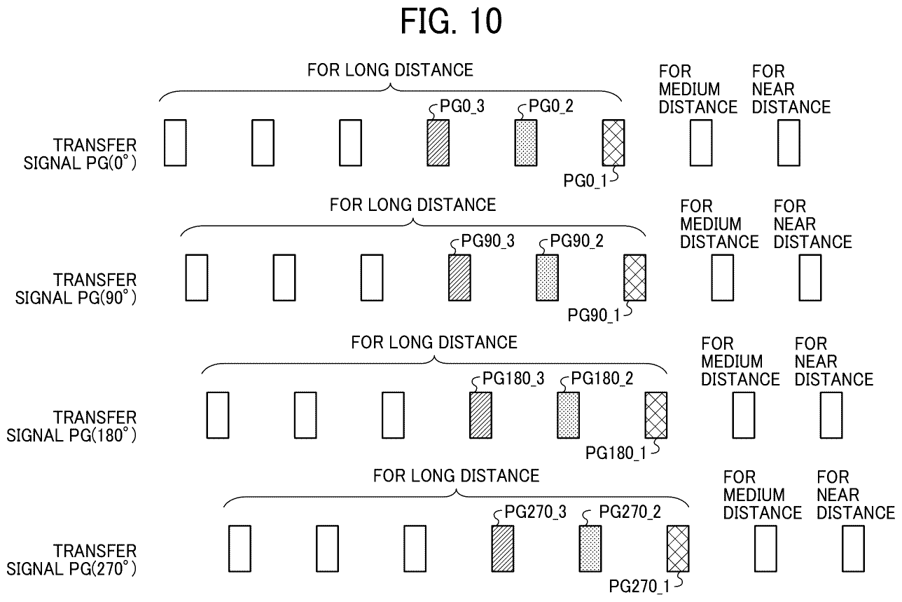

FIG. 7 is a diagram illustrating image-capturing timing of phase images in the image-capturing system according to the present embodiment. FIG. 8 is a diagram illustrating another example of image-capturing timing of phase images in the image-capturing system according to the present embodiment. FIG. 9 is a diagram illustrating yet another example of image-capturing timing of phase images in the image-capturing system according to the present embodiment. Descriptions are given below of image-capturing timing of phase images in the image-capturing system 1 according to the present embodiment, with reference to FIGS. 7 to 9. Note that, in the description above with reference to FIG. 2, it is assumed that the number of sets of the modulation switch and the capacitor is two. By contrast, in the description below, it is assumed that the number of sets of the modulation switch and the capacitor is four so that phase signals of four phases, namely, 0-degree, 90-degree, 180-degree, and 270-degree phases are acquired in one frame period, and, for example, the delay time Td and the distance D are calculated by the above-described sinusoidal modulation method. In this case, the transfer signals, output from the image-capturing control circuit 12, for turning on the modulation switches are collectively referred to as “transfer signals TR.” In the following description, the acquisition of the phase signal by the light-receiving sensor 11 may be referred to as “capturing of (two-dimensional image) phase image” corresponding to each pixel of the light-receiving sensor 11.

The image-capturing control circuit 12 sequentially outputs the transfer signals TR in 0-degree, 90-degree, 180-degree, and 270-degree phases to the corresponding modulation switches with respect to the irradiation light emitted from the light projection device 10 (the modulation signal output to the light projection device 10), so as to turn on the modulation switches. With this operation, charges are accumulated in the corresponding capacitors. Then, the light-receiving sensor 11 can acquire the 0-degree, 90-degree, 180-degree, and 270-degree phase signals in one frame period. In this case, the amount of the reflected light of the irradiation light, reflected from a measured target at a long distance is smaller than that reflected from a measured target at a near distance. Accordingly, as illustrated in FIG. 7, the light projection device 10 increases the length of exposure time of the irradiation light in order to acquire a phase image for long distance (may be referred to as “long-distance phase image” in the following description), and the light-receiving sensor 11 acquires a phase signal multiple times in each phase (captures phase images). Then, the addition and correction unit 13 performs addition processing on the multiple phase images acquired under the same condition for each phase, to generate a summed phase image for each phase. Then, the distance calculation unit 14 generates a distance image indicating the distance to the measured target 3 based on the summed phase images generated by the addition and correction unit 13. As described above, when the measured target is at a long distance, i.e., when the amount of reflected light received by the light-receiving sensor 11 is small, the phase image is captured multiple times in each phase, and the addition processing is performed on the multiple phase images in each phase. Use of the summed phase image thus acquired can increase the accuracy of the distance calculated as the distance image.

Subsequently, as illustrated in FIG. 7, the light projection device 10 performs the irradiation with an exposure time for acquiring a phase image for medium distance (may be referred to as “medium-distance phase image” in the following description), and the light-receiving sensor 11 acquires a phase signal multiple times in each phase (captures phase images). Subsequently, as illustrated in FIG. 7, the light projection device 10 performs the irradiation with an exposure time for acquiring a phase image for near distance (may be referred to as “near-distance phase image” in the following description), and the light-receiving sensor 11 acquires a phase signal multiple times in each phase (captures phase images).

In FIG. 7, only the long-distance phase image is acquired multiple times in order to simplify the description, and the medium-distance and near-distance phase images are acquired once, but the number of acquisition of phase image is not limited thereto. For example, the length of exposure time may be increased in the order of near distance, medium distance, and long distance so that number of phase images to be acquired (captured) are increased in that order. The multiple phase images of the same phase may be added together, to generate a summed phase image, for each of the different conditions (near-distance exposure time, medium-distance exposure time, and long-distance exposure time).

Further, the multiple phase images acquired under the same condition, to be added together for each phase for generating the summed phase images are not necessarily acquired in one period (exposure time) as illustrated in FIG. 7. Alternatively, as illustrated in FIG. 8, the addition processing may be performed on multiple phase images acquired over multiple periods, to generate a summed phase image. For example, the multiple phase images subjected to the addition processing for generating a summed phase image may include not only the multiple phase images for each phase captured in one exposure with the exposure time for long distance (may be also “long-distance exposure time), but also, as illustrated in FIG. 8, the multiple phase images for each phase captured in another period, which is another long-distance exposure time after the medium-distance exposure time and the near-distance exposure time. In FIG. 8, the multiple periods subjected to the addition processing are the long-distance exposure times, but the same processing may be performed for medium distance and for near distance. Although FIG. 8 illustrates a case where the number of multiple periods subjected to the addition processing is two, but the number of the multiple periods is not limited thereto, and may be three or more.

Further, although the description is given above of capturing the phase images in the order of long distance, medium distance, and near distance with reference to FIG. 7, alternatively, as illustrated in FIG. 9, capturing the phase images may be performed in the order of near distance, medium distance, and long distance.

### Shaking Correction

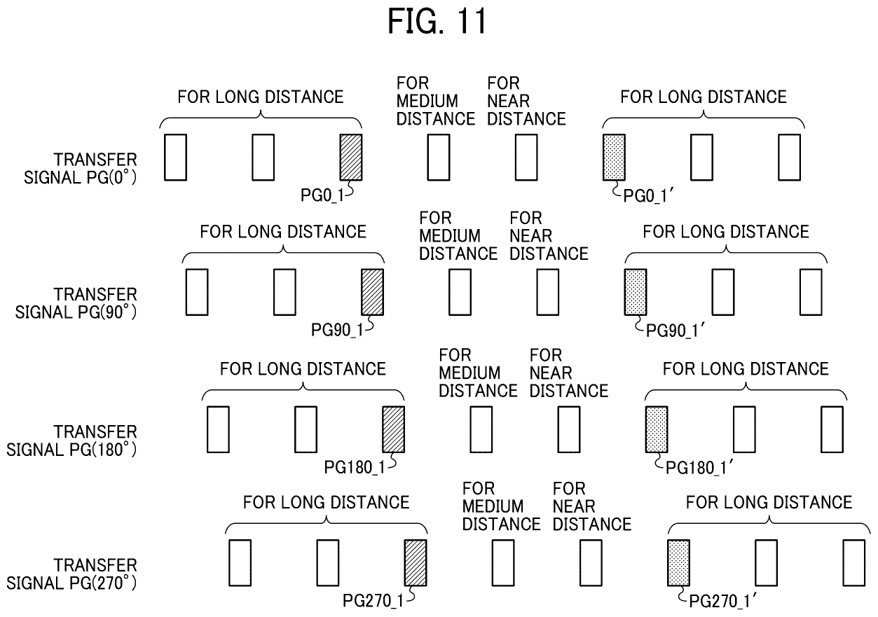

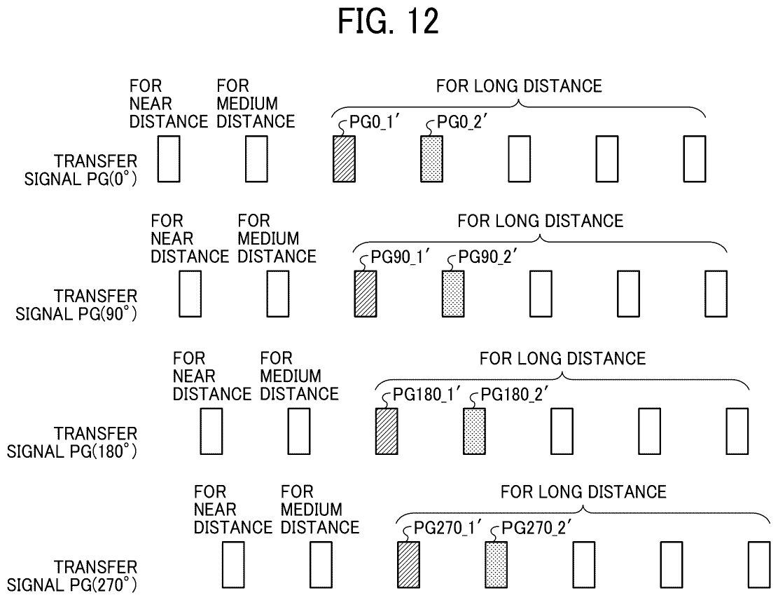

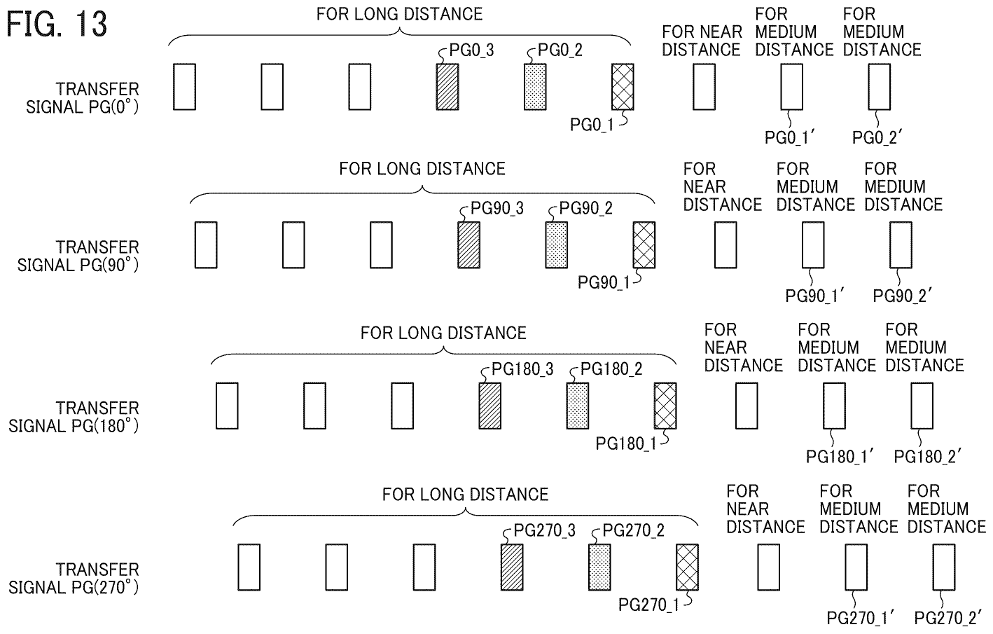

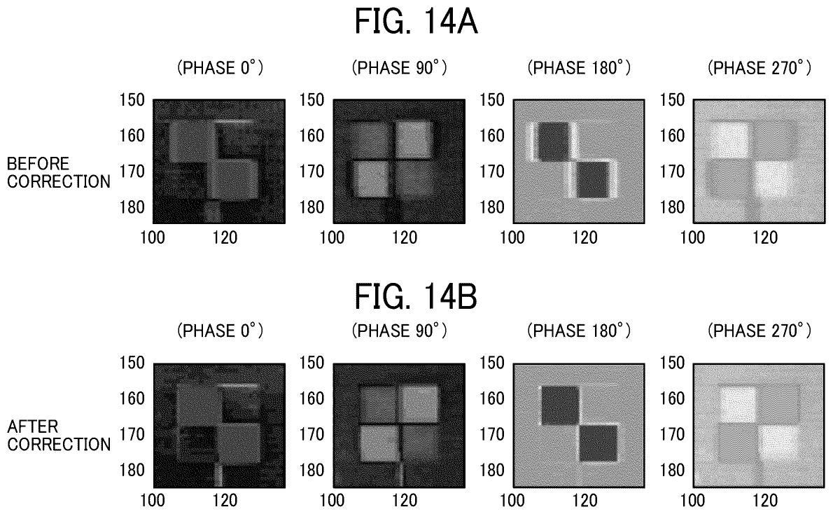

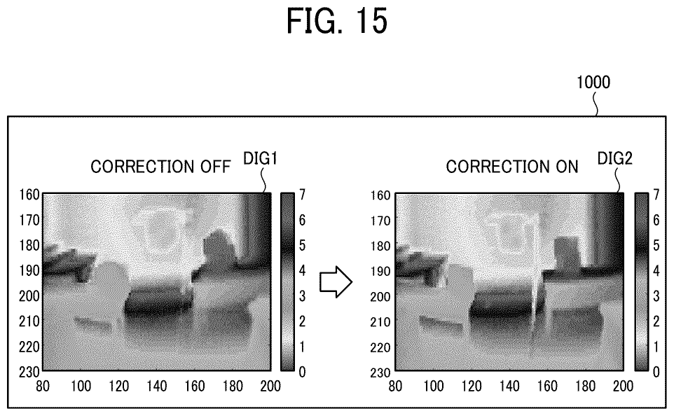

FIG. 10 is a diagram illustrating selection of a reference phase image from among the phase images captured by the image-capturing system according to the present embodiment. FIG. 11 is a diagram illustrating another selection of the reference phase image from among the phase images captured by the image-capturing system according to the present embodiment. FIG. 12 is a diagram illustrating yet another selection of the reference phase image from among the phase images captured by the image-capturing system according to the present embodiment. FIG. 13 is a diagram illustrating yet another selection of the reference phase image from among the phase images captured by the image-capturing system according to the present embodiment. FIG. 14A is a diagram illustrating phase images before shaking correction by the image-capturing system according to the present embodiment. FIG. 14B is a diagram illustrating phase images after shaking correction by the image-capturing system according to the present embodiment. First, a description is given of a method for selecting the reference phase image which is a phase image used for performing shaking correction by the addition and correction unit 13, with reference to FIGS. 10 to 14B.

As described above, use of the summed phase image obtained by adding the multiple phase images of the same phase acquired under the same condition can increase the accuracy of the distance calculated as the distance image. Even so, there may be shifts among the multiple phase images due to a shake of a user holding the phase-image capturing device 5 (may be also referred to as “shake of the device”) or a shake of the object (measured target). When the addition processing is performed to generate the summed phase image from the phase images having a shift, the shift may result in a decrease in the accuracy of the distance measurement. Therefore, in the image-capturing system 1 according to the present embodiment, the addition and correction unit 13 performs shaking correction for correcting the shift among the multiple phase images due to a shake of the device or a shake of the object.

First, the addition and correction unit 13 focuses on the long-distance phase images, which are large in number of phase images for each phase among the phase images for each phase obtained from the light-receiving sensor 11 in the exposure times for different distances. In the example illustrated in FIG. 10, in each of different phases, the number of phase images obtained in the long-distance exposure time is greater than the number of phase image in the middle-distance exposure time and the number of phase image obtained in the near-distance exposure time. The long-distance exposure time serves as a first condition and an example of a first period. The phase images obtained in the long-distance exposure time serves as first phase images. The middle-distance or near-distance exposure time serves as a second condition and an example of a second period. The phase image obtained in the middle-distance or near-distance exposure time serves as a second phase image. Accordingly, the addition and correction unit 13 focuses on the long-distance phase images which are greater in number. Then, the addition and correction unit 13 selects, for each phase, a reference phase image used for the shaking correction from the phase images obtained in the long-distance exposure time. Subsequently, using the selected reference phase image, the addition and correction unit 13 calculates a motion amount (shift amount) among the multiple phase images caused by a shake of the device or the object. Then, the addition and correction unit 13 performs correction (shaking correction) on the multiple long-distance phase images of the same phase, using the calculated motion amount, performs the addition processing on the corrected long-distance phase images of the same phase, and generates a summed phase image for each phase. In addition, the addition and correction unit 13 performs the shaking correction on one or more middle-distance phase images and one or more near-distance phase images using the motion amount calculated from the reference phase image for long distance.

To be more specific, when selecting the reference phase image to be used for shaking correction from among the 0-degree phase images obtained in the long-distance exposure time, as illustrated in FIG. 10, the addition and correction unit 13 selects not a phase image obtained at a center time point in the long-distance exposure time, but one of the phase images (phase images PG0_1, PG0_2, and PG0_3) obtained at a time point closer to a different exposure time (the middle-distance exposure time in the example of FIG. 10) different from the long-distance exposure time. Subsequently, using the selected reference phase image, the addition and correction unit 13 calculates a motion amount (shift amount) among the multiple phase images caused by a shake of the device or the object. Then, the addition and correction unit 13 performs correction (shaking correction) on the multiple 0-degree phase images for long distance using the calculated motion amount, performs the addition processing on the corrected phase images, to generate a summed phase image of 0-degree phase for long distance. Similarly, when selecting a reference phase image to be used for shaking correction from among the 90-degree phase images obtained in the long-distance exposure time, the addition and correction unit 13 selects one of phase images PG90_1, PG90_2, and PG90_3 obtained at a time point closer to the different exposure time (the middle-distance exposure time in FIG. 10). Then, the addition and correction unit 13 calculates a motion amount, performs shaking correction, and generates a summed phase image of 90-degree phase. Further, when selecting a reference phase image to be used for shaking correction from among the 180-degree phase images obtained in the long-distance exposure time, the addition and correction unit 13 selects one of phase images PG180_1, PG180_2, and PG180_3 obtained at a time point closer to the different exposure time (the middle-distance exposure time in FIG. 10). Then, the addition and correction unit 13 calculates a motion amount, performs shaking correction, and generates a summed phase image of 180-degree phase. Further, when selecting a reference phase image to be used for shaking correction from among the 270-degree phase images obtained in the long-distance exposure time, the addition and correction unit 13 selects one of phase images PG270_1, PG270_2, and PG270_3 obtained at a time point closer to a different exposure time (the middle-distance exposure time in the example of FIG. 10). Then, the addition and correction unit 13 calculates a motion amount, performs shaking correction, and generates a summed phase image of 270-degree phase. Basically, selecting the phase images PG0_1, PG90_1, PG180_1, and PG270_1 corresponding to the time point closest to the different exposure time as the reference phase images results in the generation of a summed phase image with little shift from the phase images obtained in the different exposure time. However, the phase images selected as the reference phase images may be changed as appropriate depending on the situation relating to the phase images.

As described above, a motion amount is calculated using the reference phase image that is a phase image obtained at a time point closer to a different exposure time, selected from among the phase images obtained in the long-distance exposure time. This is advantageous in increasing the accuracy of shaking correction performed on the phase images obtained in the different exposure time (e.g., the medium-distance or near-distance exposure time) using this motion amount since this motion amount is calculated with reference to the reference phase image obtained at the time point closer to the different exposure time (e.g., the medium-distance or near-distance exposure time).

A description is given of a method for the addition and correction unit 13 to calculate a motion amount (shift amount) among the multiple phase images caused by a shake of the device or the object, using the selected reference phase image. For example, edges of the measured target are extracted from the reference phase image as feature points of the measured target. Then, the edges extracted as the feature points of the measured target are compared between the reference phase image and the other phase images, and align the other phase images with the reference phase image, so as to calculate the motion amount.

The following is other methods for the addition and correction unit 13 to calculate a motion amount (shift amount) among the multiple phase images caused by a shake of the device or the object, using the selected reference phase image. For example, motion amounts ΔX and ΔY between a certain reference phase image and another phase image in a time Nt can be calculated by a typical process of obtaining an optical flow or a machine learning method disclosed in the following reference article.
Article name
Tackling 3D ToF Artifacts Through Learning and the FLAT Dataset
Author
Qi Guo (SEAS, Harvard University)
Iuri Frosio
Orazio Gallo
Todd Zickler (SEAS, Harvard University)
Jan Kautz
Publication date Monday, Sept. 10, 2018
Monday, Sep. 10, 2018
Publishing source
ECCV (European Conference on Computer Vision) 2018
Uniform Resource Locator (URL)
https://research.nvidia.com/publication/2018-09_Tackling-3D-ToF

Alternatively, for example, a machine shaking model due to shaking of a user hand or an accelerometer may be introduced, and a motion may be predicted from the information therefrom and motion amount information of multiple phase images obtained in a long-distance exposure time.

Further, in the case where the addition processing is performed on the multiple phase images acquired in multiple periods, which is described above with reference to FIG. 8, the reference phase image can be selected as illustrated in FIG. 11. Specifically, the multiple phase images subjected to the addition processing include not only the multiple phase images captured for each phase in the first long-distance exposure time, but also the multiple phase images captured for each phase in the subsequent long-distance exposure time after the medium-distance exposure time and the short-distance exposure time.

To be more specific, as illustrated in FIG. 11, the addition and correction unit 13 selects, from among 0-degree phase images obtained in the multiple long-distance exposure times temporally separated from each other, phase images PG0_1 and PG0_1′, which are respectively obtained at time points closer to different exposure times (the medium-distance and near-distance exposure times in FIG. 11) different from the long-distance exposure times, as reference phase images to be used for shaking correction. Subsequently, using the selected reference phase images, the addition and correction unit 13 calculates a motion amount (shift amount) among the multiple phase images caused by a shake of the device or the object. Then, the addition and correction unit 13 performs correction (shaking correction) on the multiple 0-degree phase images for long distance using the calculated motion amount, performs the addition processing on the corrected phase images, to generate a summed phase image of 0-degree phase for long distance. Similarly, the addition and correction unit 13 selects, from among 90-degree phase images obtained in the multiple long-distance exposure times temporally separated from each other, phase images PG90_1 and PG90_1′, which are respectively obtained at time points closer to the different exposure times (the medium-distance and near-distance exposure times in FIG. 11), as reference phase images to be used for shaking correction. Then, the addition and correction unit 13 calculates a motion amount, performs shaking correction, and generates a summed phase image of 90-degree phase. Further, the addition and correction unit 13 selects, from among 180-degree phase images obtained in the multiple long-distance exposure times temporally separated from each other, phase images PG180_1 and PG180_1′, which are respectively obtained at time points closer to the different exposure times (the medium-distance and near-distance exposure times in FIG. 11), as reference phase images to be used for shaking correction. Then, the addition and correction unit 13 calculates a motion amount, performs shaking correction, and generates a summed phase image of 180-degree phase. Further, the addition and correction unit 13 selects, from among 270-degree phase images obtained in the multiple long-distance exposure times temporally separated from each other, phase images PG270_1 and PG270_1′, which are respectively obtained at time points closer to the different exposure times (the medium-distance and near-distance exposure times in FIG. 11), as reference phase images to be used for shaking correction. Then, the addition and correction unit 13 calculates a motion amount, performs shaking correction, and generates a summed phase image of 270-degree phase.

For performing the addition processing on multiple phase images acquired in a long-distance exposure time in the case where phase images are obtained in the order of near-distance phase images, medium-distance phase images, and long-distance phase images as described above with reference to FIG. 9, a reference phase image can be selected as illustrated in FIG. 12.

Specifically, as illustrated in FIG. 12, the addition and correction unit 13 selects, from among the 0-degree phase images obtained in the long-distance exposure time, not phase images obtained at center time points in the long-distance exposure time, but phase images PG0_1′ and PG0_2′ obtained at time points closer to the different exposure time (the middle-distance exposure time in FIG. 12) different from the long-distance exposure time, as the reference phase images to be used for shaking correction. Subsequently, using the selected reference phase image, the addition and correction unit 13 calculates a motion amount (shift amount) among the multiple phase images caused by a shake of the device or the object. Then, the addition and correction unit 13 performs correction (shaking correction) on the multiple 0-degree phase images for long distance using the calculated motion amount, performs the addition processing on the corrected phase images, to generate a summed phase image of 0-degree phase for long distance. Similarly, the addition and correction unit 13 selects, from among 90-degree phase images obtained in the long-distance exposure time, phase images PG90_1′ and PG90_2′, which are obtained at time points closer to the different exposure time (the medium-distance exposure time in FIG. 12), as reference phase images to be used for shaking correction. Then, the addition and correction unit 13 calculates a motion amount, performs shaking correction, and generates a summed phase image of 90-degree phase. Further, the addition and correction unit 13 selects, from among 180-degree phase images obtained in the long-distance exposure time, phase images PG180_1′ and PG180_2′, which are obtained at time points closer to the different exposure time (the medium-distance exposure time in FIG. 12), as reference phase images to be used for shaking correction. Then, the addition and correction unit 13 calculates a motion amount, performs shaking correction, and generates a summed phase image of 180-degree phase. Further, the addition and correction unit 13 selects, from among 270-degree phase images obtained in the long-distance exposure time, phase images PG270_1′ and PG270_2′, which are obtained at time points closer to the different exposure time (the medium-distance exposure time in FIG. 12), as reference phase images to be used for shaking correction. Then, the addition and correction unit 13 calculates a motion amount, performs shaking correction, and generates a summed phase image of 270-degree phase.

As described above, also in the examples illustrated in FIGS. 11 and 12, use of a motion amount calculated using one or more reference phase images obtained at a time point closer to a different exposure time, selected from among the phase images obtained in the long-distance exposure time, is advantageous in increasing the accuracy of shaking correction performed on the phase images obtained in the different exposure time (e.g., the medium-distance or near-distance exposure time).

Further, as illustrated in FIG. 13, the addition and correction unit 13 may perform addition processing on the multiple phase images acquired in the medium-distance exposure time, in addition to performing addition processing on the multiple phase images acquired in the long-distance exposure time. In this case, for example, the image-capturing control circuit 12 controls the light-receiving sensor 11 to capture the phase images in the order of the long-distance phase images, the-near distance phase images, and the medium-distance phase images. Then, the addition and correction unit 13 can select, from among the phase images obtained in the long-distance exposure time, a phase image (the phase image PG0_1, PG90_1, PG180_1, or PG270_1) obtained at a time point close to the different exposure time (the near-distance exposure time) as a reference phase image, and select, from among the phase images obtained in the medium-distance exposure time, a phase image (the phase image PG0_1′, PG90_1′, PG180_1′, or PG270_1′) obtained at a time point close to the different exposure time (the near-distance exposure time) as a reference phase image. As a result, the accuracy of correction can increase.

Although the reference phase images are selected from the multiple phase images in the periods of the same type of exposure (for example, the long-distance exposure time) in FIGS. 10 to 12, the selection of the reference phase images is not limited thereto. Alternatively, the reference phase images for calculating a motion amount over phase images of different exposure times may be selected. For example, in the case of the phase image capture timing illustrated in FIG. 10, the addition and correction unit 13 may select, as the reference phase images, one (e.g., for the 0-degree phase, the phase image PG0_1) of the long-distance phase images adjacent to the medium-distance phase image and one of the medium-distance phase images adjacent to the long-distance phase images.

With reference to FIGS. 14A and 14B, a description is given below of summed phase images obtained by addition processing on phase images on which the above-described shaking correction is performed and summed phase images obtained by addition processing on phase images on which the shaking correction is not performed, when the image-capturing system 1 performs image- capturing of the measured target 3. FIG. 14A illustrates summed phase images generated from the 0-degree, 90-degree, 180-degree, and 270-degree phase images on which shaking correction is not performed. As can be seen from FIG. 14A, the edges of the measured target 3 is blurred in the summed phase images obtained by the addition processing due to the shift occurring in the multiple phase images caused by a shake of the device or the measured target 3. By contrast, FIG. 14B illustrates summed phase images generated from 0-degree, 90-degree, 180-degree, and 270-degree phase images on which shaking correction has been performed. As can be seen from FIG. 14B, the edges of the measured target 3 is clearer in the summed phase images obtained by the addition processing on the multiple phase images in which the shift caused by a shake of the device or the object calculated as a motion amount is corrected.

### Display of Distance Image

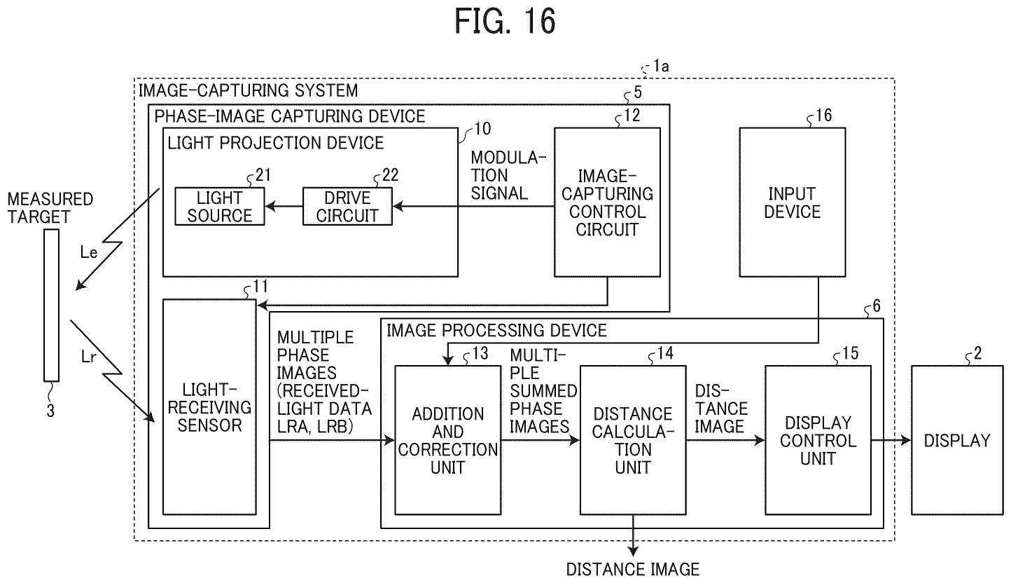

FIG. 15 is a diagram illustrating a screen image displaying a distance image obtained without the shaking correction and a distance image obtained with the shaking correction by the image-capturing system according to the present embodiment. A description is given below of displaying a distance image performed by the image-capturing system 1 according to the present embodiment with reference to FIG. 15.

FIG. 15 illustrates a screen image 1000 for displaying, on the display 2, a distance image by the display control unit 15 of the image processing device 6 of the image-capturing system 1. The distance image is generated by the distance calculation unit 14. As illustrated in FIG. 15, the screen image 1000 includes a distance image DIG1 and a distance image DIG2.

The distance image DIG1 is generated by the distance calculation unit 14 based on the summed phase images without the shaking correction by the addition and correction unit 13. The distance image DIG1 serves as a first distance image.

The distance image DIG2 is generated by the distance calculation unit 14 based on the summed phase images on which the shaking correction has been performed by the addition and correction unit 13. The distance image DIG2 serves as a second distance image.

By displaying the distance image without the shaking correction and the distance image with the shaking correction side by side in this way, the effect of the shaking correction is presented.

There may be cases where the amount of shake of the device is too large to be corrected. Alternatively, there may be cases where a movement of the measured target blurs a region of the image or prevents the calculation of a correct distance in a region of the image. In such cases, the display control unit 15 may display, on the screen image 1000, the blurred region or, for example, a message to prompt a user to perform re-generation of the distance image. Such an action can allow the user to know that there is a shake of the device or the object in the captured phase image and to perform processing again so as to eliminate the shake.

As described above, in the image-capturing system 1 according to the present embodiment, the light-receiving sensor 11 captures an image of the measured target 3 by receiving the light emitted from the light source 21 and reflected from the measured target 3. The image-capturing control circuit 12 controls the light-receiving sensor 11 to receive the reflected light and capture multiple phase images for each of multiple phases. The addition and correction unit 13 performs addition processing on the multiple phase images of the same phase, captured by the light-receiving sensor 11 under the same condition, to generate a summed phase image. The multiple phase images of the multiple phases include multiple first phase images (for example, long-distance phase images) captured under a first condition (for example, long-distance exposure time) and one or more second phase images (for example, medium-distance phase images and near-distance phase images) captured under a second condition (for example, medium-distance exposure time and near-distance exposure time) different from the first condition. The first phase images are greater in number than the second phase image(s). The addition and correction unit 13 calculates a motion amount among the first phase images of the same phase, corrects the first phase images of the same phase based on the motion amount, and performs addition processing to generate respective summed phase images of the multiple phases. By performing the correction (shaking correction) for a shake of the device or the measured target in this manner, the multiple phase images can be processed for reducing a decrease in distance calculation accuracy.

In the image-capturing system 1 according to the present embodiment, the distance calculation unit 14 calculates the distance to the measured target 3 based on the summed phase images respectively acquired for the multiple phases. Further, the distance calculation unit 14 generates a distance image indicating the distance to the measured target 3 based on the summed phase images respectively acquired for the multiple phases, and the display control unit 15 causes the display 2 to display the distance image on a display. This operation allows to the user to visually confirm the distance to the measured target 3.

In the image-capturing system 1 according to the present embodiment, the addition and correction unit 13 further generates a summed phase image by addition processing without correction, The distance calculation unit 14 generates a first distance image (for example, the distance image DIG1) based on the summed phase image generated by addition processing without correction, and generates a second distance image (for example, the distance image DIG2) based on the summed phase image generated by addition processing after correction. The display control unit 15 displays, on the display 2, the first distance image and the second distance image. By displaying the distance image without the correction and the distance image with the correction side, the effect of the shaking correction is presented.

### Modification

Descriptions are given below of an image-capturing system according to a modification, focusing on differences from the above-described image-capturing system 1. In the above-described embodiment, the addition and correction unit 13 automatically selects the reference phase image for calculating the motion amount from the phase images captured by the light-receiving sensor 11. By contrast, in the present modification described below, selection by a user of a reference phase image is received.

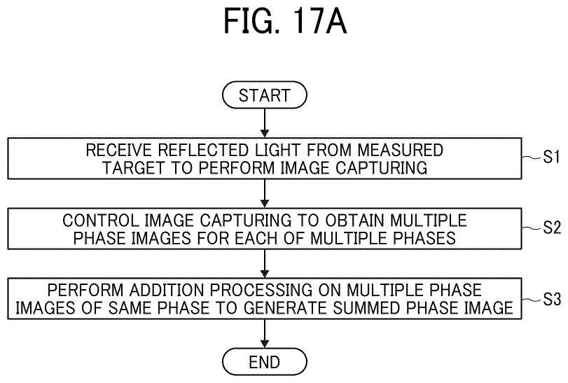

FIG. 16 is a diagram illustrating a schematic configuration of an image-capturing system according to the modification of the above-described embodiment. A description is given below of the overview of the configuration and operation of an image-capturing system 1a according to the present modification, with reference to FIG. 16.

As illustrated in FIG. 16, the image-capturing system 1a includes the phase-image capturing device 5, the image processing device 6, and an input device 16 (input unit). The phase-image capturing device 5 includes the light projection device 10, the light-receiving sensor 11 (an image-capturing sensor), and the image-capturing control circuit 12. The image processing device 6 includes the addition and correction unit 13 (an addition unit), the distance calculation unit 14 (a distance measurement unit), and the display control unit 15. Operations of the light projection device 10, the light-receiving sensor 11, the image-capturing control circuit 12, the distance calculation unit 14, and the display control unit 15 are similar to those of the image-capturing system 1 according to the above-described embodiment. Note that the configuration of the image-capturing system 1a is not limited to the configuration illustrated in FIG. 16. For example, a part of the processing units of the image processing device 6 may be included in the phase-image capturing device 5, or a part of the processing units of the phase-image capturing device 5 may be included in the image processing device 6. Alternatively, the image-capturing system 1a may include three or more devices to which the processing units of the phase-image capturing device 5 and those of the image processing device 6 are allocated. Yet alternatively, the image-capturing system 1a may be a single apparatus or device (an image-capturing device) including the processing units mentioned above.

The addition and correction unit 13 receives the received-light data LRA and LRB output from the light-receiving sensor 11 as phase signals, and performs the correction for shaking (shaking of the capturing device or the target) on multiple phase images of two-dimensional phases corresponding to the phase signals for each pixel of the light-receiving sensor 11. The addition and correction unit 13 further performs addition processing on the multiple phase images of the same phase, to generate a summed phase image. Specifically, using a phase image selected by a user operation input via the input device 16 as the reference phase image, the addition and correction unit 13 calculates a motion amount (shift amount) among the multiple phase images caused by a shake of the device or the object. Then, the addition and correction unit 13 performs correction (shaking correction) on the multiple long-distance phase images of the same phase, using the calculated motion amount, performs the addition processing on the corrected long-distance phase images of the same phase, and generates a summed phase image for each phase. In addition, the addition and correction unit 13 performs the shaking correction on one or more middle-distance phase images and one or more near-distance phase images using the motion amount calculated from the reference phase image for long distance.

The input device 16 is, for example, a touch panel or a control panel that is included in the image-capturing system la and receives a user operation. The input device 16 may be, for example, an input interface circuit that receives a user operation signal input to, for example, an external information processing device. In either case, the input device 16 allows the user to input an operation to the image processing apparatus 6 and input the operation of selecting the reference phase image from among the respective phase images of the multiple phases as described above.

In order for the user to select the reference phase image via the input device 16, for example, the display control unit 15 may display, on the display 2, information indicating the phase images and the timing of image capture of the phase images as illustrated in FIGS. 7 to 9. The display 2 may be a display of, for example, a PC or a tablet communication terminal that includes the input device 16.

In addition to receiving the selection by the user of the reference phase image via the input device 16, the image-capturing system la may further receive, from the user, the selection of a phase image not to be subjected to the addition processing by the addition and correction unit 13 and a phase image other than the reference phase image, for example.

As described above, in the image-capturing system la according to the present modification, the input device 16 receives input from outside the image-capturing system 1a, and the addition and correction unit 13 calculates the motion amount using the reference phase image selected, from the multiple first phase images, based on the input via the input device 16. With this configuration, the correction can be performed using the reference phase image according to the user's intention.

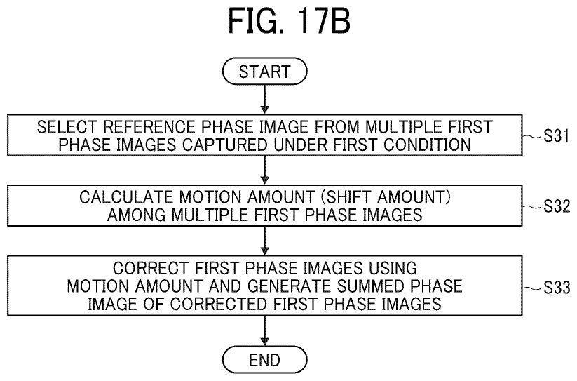

FIG. 17A is a flowchart of a process for generating an image performed by the image-capturing system 1 illustrated in FIG. 1A, 1B, or 16. The light-receiving sensor 11 (the image-capturing sensor) receives reflected light Lr which is light reflected from the measured target 3 being irradiated with the irradiation light Le emitted from the light projection device 10, to perform capturing (step S1).

At this time, the image-capturing control circuit 12 controls the light-receiving sensor 11 to receive the reflected light and capture multiple phase images for each of the multiple phases (step S2). The image-capturing control circuit 12 controls the light-receiving sensor 11 to obtain multiple first phase images under a first condition and one or more second phase images captured under a second condition different from the first condition such that the number of the first phase images is greater than the number of second phase images.

The addition and correction unit 13 then performs addition processing on the multiple phase images of the same phase, to generate a summed phase image (step S3).

The addition processing performed in step S3 includes the following steps as illustrated in FIG. 17B. For example, the addition and correction unit 13 selects the reference phase image from the multiple first phase images captured under the first condition (step S31). The reference phase image may be selected according to an operation input via the input device 16. Using the selected reference phase image, the addition and correction unit 13 calculates a motion amount (shift amount) among the multiple first phase images (step S32). Further, the addition and correction unit 13 performs correction (shaking correction) on the first phase images using the calculated motion amount, and performs the addition processing on the corrected first phase images, to generate a summed phase image (step S33).

Note that, in a case where at least a portion of the functional units of the image-capturing system 1 according to the above-described embodiment and the image-capturing system 1a according to the modification is implemented by execution of a computer program, the program can be prestored in, for example, a read-only memory (ROM). Alternatively, the computer program executed by the image-capturing system 1 according to the above-described embodiment and the image-capturing system 1a according to the modification can be provided as a file in an installable or executable format, stored in a computer-readable recording medium, such as a compact disc read-only memory (CD-ROM), a flexible disk (FD), a compact disc recordable (CD-R), or a digital versatile disk (DVD). Further, the computer program executed by the image-capturing system 1 according to the above-described embodiment and the image-capturing system la according to the modification may be stored on a computer connected to a network such as the Internet, to be downloaded via the network. Further, the computer program executed by the image-capturing system 1 according to the above-described embodiment and the image-capturing system 1a according to the modification may be provided or distributed via a network such as the Internet. The computer program to be executed by the image-capturing system 1 according to the above-described embodiment and the image-capturing system 1a according to the modification has a module structure including at least one of the above-described functional units. Regarding the actual hardware related to the computer program, the CPU reads and executes the computer program from the above-described memory to be loaded onto the main memory to implement the above-described functional units.

The present disclosure includes the following aspects.

In Aspect 1, an image-capturing system includes an addition unit configured to perform, for each of multiple phases, addition processing on multiple phase images of the same phase among multiple received phase images, to generate a summed phase image.

The multiple received phase images include multiple first phase images captured under a first condition and one or more second phase images captured under a second condition different from the first condition, and the first phase images is greater in number than the second phase image (or second phase images).

In the image-capturing system, the addition unit calculates a motion amount at least among the multiple first phase images of the same phase, corrects the multiple first phase images of the same phase based on the motion amount, and generates the summed phase image for each of multiple phases by the addition processing.

According to Aspect 2, in the image-capturing system of Aspect 1, the multiple first phase images are captured in a first period, and the one or more second phase images are captured in a second period different from the first period.

The addition unit selects, from among the multiple first phase images captured in the first period, one first phase image captured at a time closer to the second period than a center of the first period, as a first reference phase image, and calculates the motion amount using the first reference phase image.

According to Aspect 3, in the image-capturing system of Aspect 2, the first period includes multiple temporally separated periods.

According to Aspect 4, in the image-capturing system of Aspect 2, the multiple received phase images further include multiple third phase images captured in a third period, different from the first period and the second period, under a third condition different from the first condition and the second condition.

The second period is between the first period and the third period, and the addition unit selects, from among the multiple third phase images captured in the third period, one third phase image captured at a time closer to the second period than a center of the third period, as a second reference phase image, and calculates the motion amount using the second reference phase image.

According to Aspect 5, the image-capturing system of any one of Aspects 1 to 4 further includes an image-capturing device that includes a light source to emit irradiation light, and a light-receiving sensor to receive reflected light of the irradiation light reflected by an object and output a light-receiving signal; and an image-capturing control unit configured to control the image-capturing device to capture the multiple phase images for each of the multiple phases.

According to Aspect 6, the image-capturing system of any one of Aspects 1 to 5 further includes an input unit to receive input from the outside. The input unit receives an input of selection of the reference phase image from among the multiple first phase images, and the addition unit calculates the motion amount using the reference phase image selected via the input unit.

According to Aspect 7, the image-capturing system of any one of Aspects 1 to 6 further includes a distance measurement unit configured to calculate a distance to an object based on the respective summed phase images of the multiple phases.

According to Aspect 8, in the image-capturing system of Aspect 7, the distance measurement unit generates a distance image indicating a distance to the object based on the respective summed phase images of the multiple phases, and the image-capturing system further includes a display control unit configured to control a display to display the distance image.

According to Aspect 9, in the image-capturing system of Aspect 8, the addition unit further performs, for each of the multiple phases, the addition processing on the multiple phase images without performing the correction, to generate another summed phase image.

The distance measurement unit generates a first distance image based on the summed phase image generated by the addition processing without the correction, and generates a second distance image based on the summed phase image generated by the addition processing with the correction.

The display control unit controls the display to display the first distance image and the second distance image.

In Aspect 10, an image-capturing device includes an image-capturing unit (image-capturing sensor) to receive reflected light of irradiation light emitted from a light source and reflected by an object, to perform image capturing, an image-capturing control unit configured to control the image-capturing unit to receive the reflected light so as to capture multiple phase images for each of multiple phases, and an addition unit configured to perform, for each of the multiple phases, addition processing on multiple phase images of a same phase, to generate a summed phase image.

The multiple phase images captured for each of the multiple phases includes multiple first phase images captured under a first condition and one or more second phase images captured under a second condition different from the first condition, and the first phase images are greater in number than the second phase image (or second phase images).

The addition unit calculates a motion amount among the multiple phase images of the same phase regarding at least the multiple first phase images, corrects the multiple first phase images of the same phase based on the motion amount, and generates the summed phase image for each of multiple phases by the addition processing.

In Aspect 11, an image-capturing method includes receiving, with an image-capturing unit, reflected light of irradiation light emitted from a light source and reflected by an object, to perform image capturing controlling, with an image-capturing control unit, the image-capturing unit to receive the reflected light so as to capture multiple phase images for each of multiple phases; and performing, with an addition unit, addition processing on multiple phase images of a same phase for each of the multiple phases, to generate a summed phase image.

In the image-capturing method, the multiple phase images captured for each of the multiple phases include multiple first phase images captured under a first condition and one or more second phase images captured under a second condition different from the first condition, and the first phase images is greater in number than the second phase image (or second phase images).

The addition processing includes calculating a motion amount among the multiple phase images of the same phase regarding at least the multiple first phase images, correcting the multiple first phase images of the same phase based on the motion amount, and generating the summed phase image for each of multiple phases by the addition processing.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general-purpose processors, special purpose processors, integrated circuits, application-specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An image-capturing system comprising
circuitry configured to:
receive multiple phase images for each of multiple phases, the multiple phase images including multiple first phase images captured under a first condition and one or more second phase images captured under a second condition different from the first condition, the multiple first phase images being greater in number than the one or more second phase images;
calculate, for each of the multiple phases, a motion amount, at least, among the multiple first phase images of a same phase;
perform correction on the multiple first phase images of the same phase based on the motion amount; and
perform addition processing on the multiple first phase images of the same phase, so as to generate a summed phase image for each of the multiple phases.

2. The image-capturing system according to claim 1,
wherein the multiple first phase images are captured in a first period, and the one or more second phase images are captured in a second period different from the first period, and
wherein the circuitry is configured to select, from among the multiple first phase images, one first phase image captured at a time closer to the second period than a center of the first period, as a first reference phase image, and calculate the motion amount using the first reference phase image.

3. The image-capturing system according to claim 2,
wherein the first period includes multiple temporally separated periods.

4. The image-capturing system according to claim 2,
wherein the multiple phase images received for each of the multiple phases further include multiple third phase images captured in a third period different from the first period and the second period, under a third condition different from the first condition and the second condition,
wherein the second period is between the first period and the third period, and
wherein the circuitry is configured to:
select, from among the multiple third phase images captured in the third period, one third phase image captured at a time closer to the second period than a center of the third period, as a second reference phase image; and
calculate a motion amount among the multiple third phase images of a same phase.

5. The image-capturing system according to claim 1, further comprising an image-capturing device, the image-capturing device including:
a light source to emit irradiation light; and
a light-receiving sensor to receive reflected light of the irradiation light reflected by an object and output a light-receiving signal,
wherein the circuitry is further configured to control the image-capturing device to capture the multiple phase images for each of the multiple phases.

6. The image-capturing system according to claim 1, further comprising an input device to receive an input from outside the image-capturing system,
wherein the input device receives an input of selection of a reference phase image from among the multiple first phase images, and
the circuitry is configured to calculate the motion amount using the reference phase image selected via the input device.

7. The image-capturing system according to claim 1,
wherein the circuitry is further configured to calculate a distance to an object based on the summed phase image of each of the multiple phases.

8. The image-capturing system according to claim 7,
wherein the circuitry is configured to:
generate a distance image indicating a distance to the object based on the summed phase image of each of the multiple phases; and
control a display to display the distance image.

9. The image-capturing system according to claim 8,
wherein the circuitry is configured to:
perform the addition processing on the multiple first phase images before the correction for each of the multiple phases, to generate other summed phase images of the multiple phases;
generate a first distance image based on the other summed phase images of the multiple phases;
generate a second distance image based on the summed phase images generated by the addition processing after the correction; and
control the display to display the first distance image and the second distance image.

10. An image-capturing device comprising:
an image-capturing sensor to receive reflected light of irradiation light emitted from a light source and reflected by an object, to perform image capturing; and
circuitry configured to:
control the image-capturing sensor to receive the reflected light so as to capture multiple phase images for each of multiple phases, the multiple phase images including multiple first phase images captured under a first condition and one or more second phase images captured under a second condition different from the first condition, the multiple first phase images being greater in number than the one or more second phase images;
calculate, for each of the multiple phases, a motion amount, at least, among the multiple first phase images of a same phase;
perform correction on the multiple first phase images of the same phase based on the motion amount; and
perform addition processing on the multiple first phase images of the same phase, so as to generate a summed phase image for each of the multiple phases.

11. An image-capturing method comprising:
receiving, with an image-capturing sensor, reflected light of irradiation light emitted from a light source and reflected by an object, to perform image capturing;
controlling the image-capturing sensor to receive the reflected light so as to capture multiple phase images for each of multiple phases, the multiple phase images including multiple first phase images captured under a first condition and one or more second phase images captured under a second condition different from the first condition, the multiple first phase images being greater in number than the one or more second phase images;
calculating, for each of the multiple phases, a motion amount, at least, among the multiple first phase images of a same phase;
performing correction on the multiple first phase images of the same phase based on the motion amount; and
performing addition processing on the multiple first phase images of the same phase, so as to generate a summed phase image for each of the multiple phases.
